(19) United States
(12) Patent Application Publication
(10) Pub. No.: US 2015/0272147 A1
(43) Pub. Date: Oct. 1, 2015

(54) UV LIGHT-BLOCKING FERMENTING CONTAINER SYSTEM AND RELATED METHODS

(71) Applicants: Sharon Ericson, Amherst, NH (US); Sarah Ericson, Amherst, NH (US); Mark Ericson, Amherst, NH (US)

(72) Inventors: Sharon Ericson, Amherst, NH (US); Sarah Ericson, Amherst, NH (US); Mark Ericson, Amherst, NH (US)

(21) Appl. No.: 14/669,114

(22) Filed: Mar. 26, 2015

Related U.S. Application Data
(60) Provisional application No. 61/970,517, filed on Mar. 26, 2014.

(51) Int. Cl. A23B 7/10

(52) U.S. Cl. CPC A23B 7/10

(57) ABSTRACT

A UV light-blocking fermenting container system and related methods are disclosed. The fermenting container system includes a fermenting container having a lid, wherein the lid has at least one hole positioned there through. An airlock device is positioned at least partially within the at least one hole, wherein the airlock device extends away from the lid. A fabric cover is positioned surrounding the fermenting container, wherein the cover has at least a first opening positioned at a first end thereof, wherein the first opening is positioned surrounding a portion of the airlock device proximate to the at least one hole, and wherein a size of the first opening is selectively adjustable.

### CROSS REFERENCE TO RELATED APPLICATION

This application claims benefit of U.S. Provisional Application Ser. No. 61,970,517 entitled, “Fermenting Container System with Fabric Cover” filed Mar. 26, 2014, the entire disclosure of which is incorporated herein by reference.

### FIELD OF THE DISCLOSURE

The present disclosure is generally related to fermenting container systems and more particularly is related to a UV light-blocking fermenting container system and related methods.

### BACKGROUND OF THE DISCLOSURE

Fermentation of food products is common in industrial and at-home food production. Fermentation generally includes the conversion of carbohydrates to alcohols, organic acids, and carbon dioxide using yeasts, bacteria, or a combination thereof, under anaerobic conditions, depending on the type of fermentation. In a similar field to fermentation, bacteria and/or yeast can create energy from carbohydrates via aerobic means, using cellular respiration. While industrial fermenters may include large industrial machinery, at-home fermentation is often facilitated with glass jars, crocks, or similar containers, in which food can be sealed under anaerobic conditions. One particular use of at-home fermenting systems is with the pickling of food products, where the food products are placed within a fermenting jar within a solution of brine and left for a period of time to culture and age. While at-home fermenting of food products remains popular, there are some drawbacks, including the difficulty in providing optimal conditions for the fermentation process. In particular, it can often be difficult to prevent UV light from affecting the fermenting food product and subsequently neutralizing numerous fermentative microbes and their resulting metabolites, which is essential to the fermentation process and other required bacteria. As a result, the nutritional benefits of the fermented food product can be significantly decreased.

Thus, a heretofore unaddressed need exists in the industry to address the aforementioned deficiencies and inadequacies.

### SUMMARY OF THE DISCLOSURE

Embodiments of the present disclosure provide a fermenting container system. Briefly described, in architecture, one embodiment of the system, among others, can be implemented as follows. The fermenting container system includes a fermenting container having a lid, wherein the lid has at least one hole positioned there through. An airlock device is positioned at least partially within the at least one hole, wherein the airlock device extends away from the lid. A fabric cover is positioned surrounding the fermenting container, the fabric cover having at least a first opening positioned at a first end thereof, wherein the first opening is positioned surrounding a portion of the airlock device proximate to the at least one hole, and wherein a size of the first opening is selectively adjustable.

The present disclosure can also be viewed as providing a UV light-blocking, food product fermentation system. Briefly described, in architecture, one embodiment of the system, among others, can be implemented as follows. A fermentation container has a lid, wherein the lid has at least one hole positioned fully through a thickness thereof, wherein a food product is housed within an interior of the fermentation container. An airlock device is positioned at least partially within the at least one hole, wherein the airlock device is connected between the interior of the fermentation container and an external atmosphere of the fermentation container. A UV light-blocking fabric cover is removably positioned surrounding the fermenting container, wherein the UV light-blocking fabric cover has at least a first opening positioned at a first end thereof, wherein the first opening is positioned surrounding a portion of the airlock device proximate to the at least one hole. A conduit is formed within the UV light-blocking fabric cover and is positioned around a circumference of the first opening, wherein a drawstring is positioned through the conduit, wherein a size of the first opening is selectively adjustable by moving the drawstring within the conduit.

The present disclosure can also be viewed as providing a method of blocking UV light in a food product fermentation system. In this regard, one embodiment of such a method, among others, can be broadly summarized by the following steps: providing a food product fermentation container having a lid, wherein the lid has at least one hole positioned fully through a thickness thereof; positioning an airlock device at least partially within the at least one hole, whereby the airlock device is connected between an interior of the food product fermentation container and an external atmosphere of the food product fermentation container; and removably covering the food product fermentation container and the lid with a UV light-blocking fabric cover, wherein the UV light-blocking fabric cover has at least a first opening positioned at a first end thereof, wherein the first opening is positioned surrounding a portion of the airlock device proximate to the at least one hole.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic illustration of a fermenting container system, in accordance with a first exemplary embodiment of the present disclosure.

FIG. 2 is a cross-sectional side-view illustration of the fermenting container system of FIG. 1, in accordance with the first exemplary embodiment of the present disclosure.

FIG. 3 is a cross-sectional illustration of the fabric cover of FIG. 1, in accordance with the first exemplary embodiment of the present disclosure.

FIG. 4 is a detailed view cross-sectional illustration of a section of the fabric cover, in accordance with the first exemplary embodiment of the present disclosure.

FIG. 5 is a top view illustration of the fabric cover of FIG. 1, in accordance with the first exemplary embodiment of the present disclosure.

FIG. 6 is a top view illustration of the fabric cover of FIG. 1, in accordance with the first exemplary embodiment of the present disclosure.

FIG. 7 is a cross-sectional illustration of the fabric cover, in accordance with the first exemplary embodiment of the present disclosure.

FIG. 8 is a side view illustration of the fabric cover, in accordance with the first exemplary embodiment of the present disclosure.

FIG. 9 is a side view illustration of the fabric cover, in accordance with the first exemplary embodiment of the present disclosure.

FIG. 10 is a side view illustration of the fabric cover with a temperature control device, in accordance with the first exemplary embodiment of the present disclosure.

FIG. 11 is a side view illustration of the fabric cover, in accordance with a second exemplary embodiment of the present disclosure.

FIG. 12 is a flowchart illustrating a method of blocking UV light in a food product fermentation system, in accordance with the first exemplary embodiment of the present disclosure.

### DETAILED DESCRIPTION

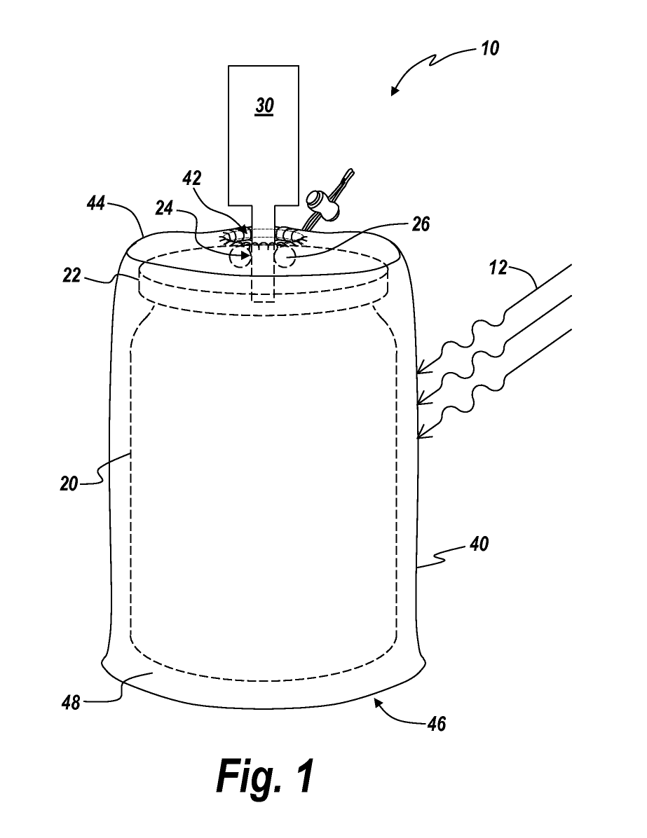

FIG. 1 is a schematic illustration of a fermenting container system 10, in accordance with a first exemplary embodiment of the present disclosure. The fermenting container system 10, which may be referred to herein simply as ‘system 10’, includes a fermenting container 20 having a lid 22. The lid 22 has at least one hole 24 positioned there through. An airlock device 30 is positioned at least partially within the at least one hole 24, wherein the airlock device 30 extends away from the lid 22. A fabric cover 40 is positioned surrounding the fermenting container 20. The fabric cover 40 has a first opening 42 positioned at one end 44 thereof, wherein the first opening 42 is positioned surrounding a portion of the airlock device 30 proximate to the at least one hole 24. A size of the first opening 42 is selectively adjustable.

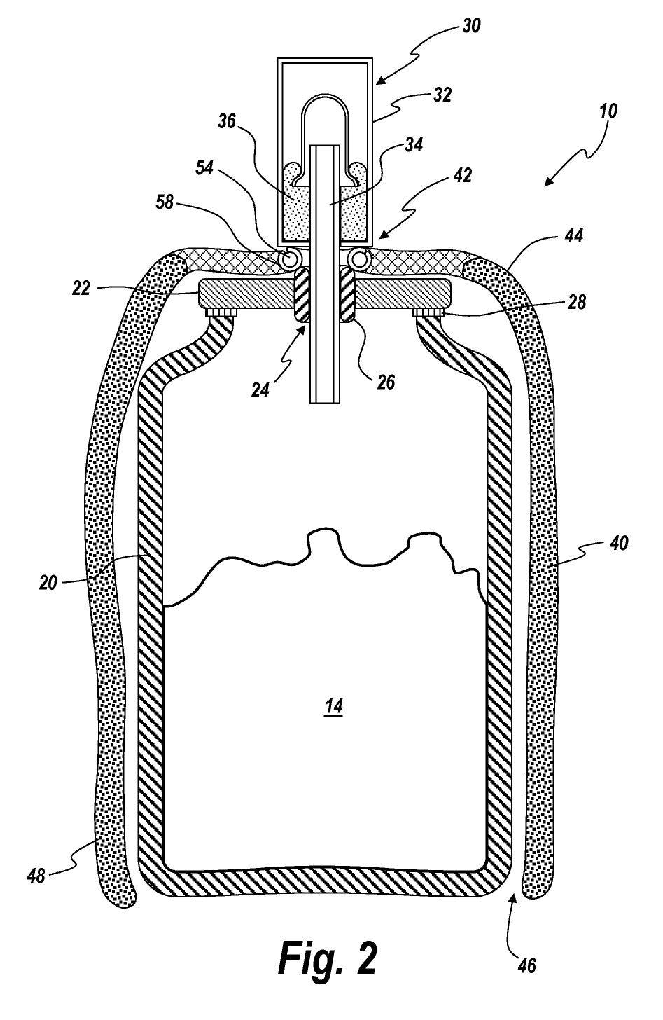

FIG. 2 is a cross-sectional side-view illustration of the fermenting container system 10 of FIG. 1, in accordance with the first exemplary embodiment of the present disclosure. With reference to FIGS. 1-2, the system 10 may be used with any type of food product fermentation and pickling processes, which may be used with various types of foods or food bases, such as vegetables, dough starters and batters, sauerkrauts, kimchi, kefir, and many others. The fermenting container 20 may be a container capable of holding a food product 14, as is shown in FIG. 2, during a fermentation process, and therefore may have a variety of sizes to fit the intended fermenting container 20. Commonly, the fermenting container 20 is a glass jar or vessel with a glass lid 22, however, other materials may also be used. The lid 22 may be positioned on the fermenting container 20 with an optional gasket 28 positioned therebetween, as shown in FIG. 2, to hermetically seal the lid 22 to the fermenting container 20, such that air can only escape through the airlock device 30. Optionally, the fermenting container 20 and lid 22 may utilize a metal retaining clip positioned over the lid 22 to retain it in place on the fermenting container 20. Other designs utilizing other features to hermetically seal the lid 22 or retain it in place may also be used. A hole 24 is formed within the lid 22 and a grommet 26 or similar device, such as an O-ring, check-valve, dry lock, or similar structure, may be positioned in the hole 24 to interface between the hole 24 and the airlock device 30.

The airlock device 30 may be installed within the lid 22 by being positioned within a central aperture of the grommet 26, such that the grommet 26 interfaces between the hole 24 within the lid 22 and the airlock device 30. The airlock device 30 may be retained in this position in such a manner as to prevent air and other contaminants from entering an interior portion of the fermenting container 20 while allowing carbon dioxide and other gasses resulting from the fermentation process to leave through the airlock 30. The airlock device 30 may allow carbon dioxide released by the fermenting food product to escape the fermenting container 20 while not allowing air from the surrounding atmosphere to enter the fermenting container 20. Without the airlock device 30, pressure may build within the fermenting container 20 to undesirable levels.

As is shown in FIGS. 1-2, the airlock device 30 may include a body 32 and a straw 34, where, when positioned within the hole 24 of the lid 22, the body 32 is positioned above the lid 22 of the fermenting container 20 and the straw 34 is positioned through the hole 24 within the lid 22. In use, the straw 34 may allow fermentation gases to exit into the body 32, which may have a fluid 36 therein. When the pressure of the gas inside the fermentation container 20 exceeds the prevailing atmospheric pressure, the gas will push its way up the stray 34, through the fluid 36, as individual bubbles, and into the outside air. The presence of the fluid 36 within the airlock device 30 prevents external air or gasses from entering the fermenting container 20. It is noted that many types of airlock devices or alternatives thereto may also be utilized, including devices such as a bung, an O-ring, a dry-lock, and a variable-closure that fits a wide-range of other types of airlock devices. Other types of airlock devices, including wet locks, check valve, and other devices known within the art may all be utilized. Furthermore, the use of grommets or O-rings with tubing that is run out of the hole in fermenting container 20 and directed collectively into a vat of water may also be used. All variations of airlock devices known within the art are considered within the scope of the present disclosure.

Since most conventional vessels for fermenting at-home are formed from glass, which is often an ultraviolet (UV) light penetrable material, the food products 14 being fermented are often exposed to UV light. UV light is electromagnetic radiation with a wavelength from 400 nm to 10 nm, which is shorter than that of visible light and thus almost always invisible to the human eye. UV light can negatively affect the fermenting food product and subsequently neutralize numerous fermentation or respiration (anaerobic or aerobic) microbes and their beneficial metabolites, which is essential to the fermentation process. While the fermenting container 20 can be placed in a dark environment, such as a closet or basement, it becomes difficult to monitor the fermentation process. Furthermore, one cannot block UV light from the fermenting container 20 using a dish towel or similar item in the kitchen, since these items are not made from UV blocking fabric, even though they may be used to block sunlight from the fermenting container 20. The fabric cover 40 may be formed partially or fully from a UV light blocking material and be positioned surrounding the fermenting container 20 to block UV light 12 from entering the fermenting container 20, thereby preserving the full integrity of the food product 14 therein.

The fabric cover 40 may be formed from a fabric material that is capable of surrounding the fermenting container 20 and blocking all or substantially all UV light 12. For example, the fabric cover 40 may be formed from a wide-range of UV-blocking fabrics, such as bamboo, hemp, canvas, flax, and any blends or combinations thereof, as well as other types of fabric not mentioned explicitly herein. When a natural fabric material is used, such as hemp or bamboo, the lignin within the fabric may provide the UV light blocking property by absorbing the UV light rays that contact the fabric material. The fabric cover 40 may be naturally UV-blocking or may be treated or dyed to have UV light blocking capabilities, or any combination thereof. It is also noted that certain natural fabrics, such as hemp and/or bamboo fabrics, have beneficial antimicrobial properties which can prevent microbial decay of the fabric. For example, hemp is naturally resistant to mold, mildew and salt water while bamboo is antimicrobial, and mold and mildew resistant. The ability of the fabric to be naturally resistant to microbial decay may allow the fabric cover 40 to be used for long periods of time in all conditions.

Commonly, the fabric cover 40 may have a cylindrical construction with a first opening 42 at one end 44, e.g., the top of the fabric cover 40, and a second opening 46 at the other end, such as a bottom 48 of the fabric cover 40. When the fabric cover 40 is in place on the fermenting container 20, the first opening 42 of the fabric cover 40 is positioned surrounding a portion of the airlock device 30 proximate to the at least one hole 24 when the system 10 is assembled. In this position, the fabric cover 40 may substantially surround the entirety of the fermenting container 20 but allow exposure of the airlock device 30. This configuration allows the airlock device 30 to be open to a surrounding atmosphere, thereby allowing release of carbon dioxide gases, but prevents UV light 12 from contacting the fermenting container 20. The exposed airlock device 30 also allows for visual monitoring of a water level or a brine level and the ability to be refilled without removing the fabric cover 40. This positioning may also make the fermenting food product 14 within the fermenting container 20 from being viewable through the fabric cover 40.

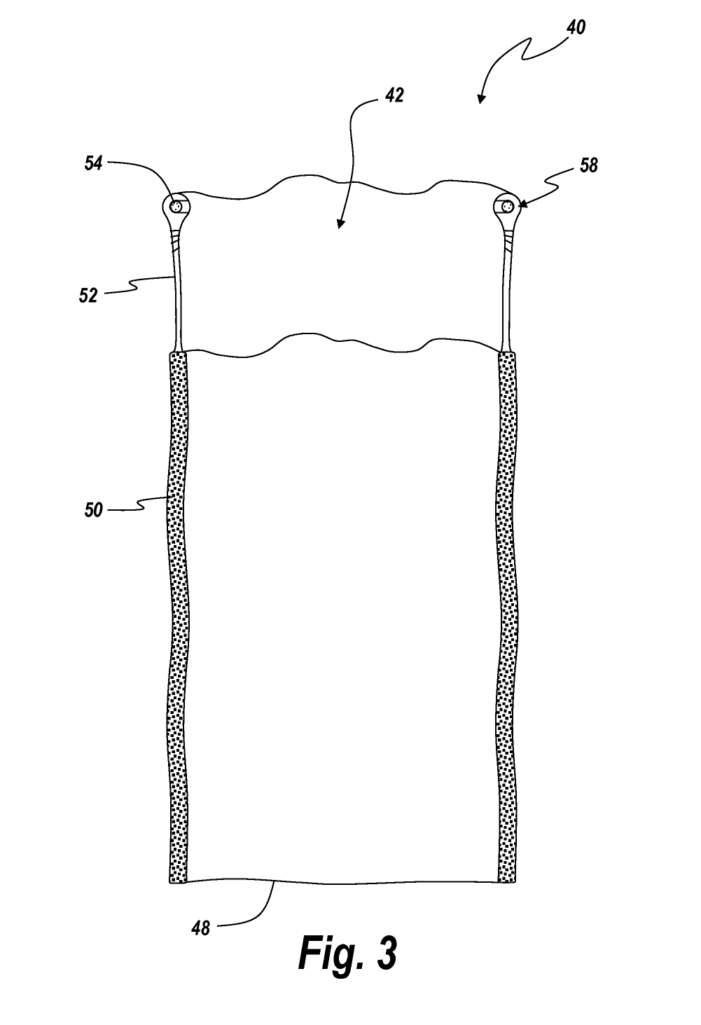

As described in detail relative to FIGS. 3-6, the size of the first opening 42 may be selectively adjustable such that it can be enlarged and shrunk, as desired. The ability to adjust the size of the first opening 42 allows for the fabric cover 40 to snugly fit against the airlock device 30, thereby efficiently preventing UV light 12 from contacting the lid 22 of the fermenting container 20. Additionally, it is noted that another benefit of the ability to adjust the size of the first opening 42 is that it allows the fabric cover 40 to easily slip over the fermenting container 20 without removal of the airlock device 30, rather than having to lift, move, or otherwise disturb the fermenting container 20 or airlock device 30 to remove the fabric cover 40. For example, the fabric cover 40 may be placed over a fermenting container 20 and airlock device 30 by slipping the airlock device 30 into the first opening 42, and then when the fabric cover 40 is fully positioned on the fermenting container 20, the first opening 42 may be cinched closed around the airlock device 30 for the UV blocking.

FIG. 3 is a cross-sectional illustration of the fabric cover 40 of FIG. 1, in accordance with the first exemplary embodiment of the present disclosure. In particular, FIG. 3 illustrates a cross-sectional cut of the fabric cover 40. As can be seen, the fabric cover 40 may be formed from two or more different fabrics having different properties. For example, the fabric cover 40 may include a first fabric material 50 that has a heavy relative weight, such as hemp or canvas, and a second fabric material 52 that has a relatively lighter weight. The first and second fabric materials 50, 52 may be connected together by sewing or another technique to form the fabric cover 40. The second fabric material 52 having the lighter weight may be used to form the portion of the fabric cover 40 where the first opening 42 is located, thereby making it easier to adjust the size of the first opening 42, as compared to a heavier fabric. In use, the second fabric material 52 constructed from a light-weight fabric, may be positioned substantially above the lid 22, whereas the heavier first fabric material 50 may be used to form the body of the fabric cover 40, such that it covers the sides of the fermenting container 20 (FIGS. 1-2), which is likely to receive the largest quantity of UV light 12 (FIG. 1).

The fabric cover 40 may offer a plurality of additional benefits beyond UV light protection. For example, the fabric cover 40 may be used to insulate the fermenting container 20 from both heat and cold, such as when the fabric cover 40 is constructed at least in part from hemp fleece or similar materials. Insulating from heat and cold may keep the temperature of the fermenting food product more uniform than it would be without the fabric cover 40. It is noted that the fabric cover 40 may insulate against a loss of heat within the fermenting container 20, the fabric cover 40 can also provide natural evaporative cooling of the fermenting container 20, such as by soaking it within water or otherwise moistening the fabric cover 40. Accordingly, the fabric cover 40 can assist with properly regulating a temperature of the fermenting container 20. Furthermore, the fabric cover 40 may protect and/or pad the fermenting container 20, keeping it from cracking or breaking when it is contacted or struck by other fermenting containers 20 or other objects. The fabric cover 40 may also be decorative, in that it provides an aesthetic appearance to the fermenting container 20, and it may help keep the fermenting container 20 from becoming dirty, such as when it is contacted by dirty fingers, dust, or other substances.

With reference to FIGS. 2-3, the first opening 42 of the fabric cover 40 may be adjustable with drawstring 54 that is positioned within a conduit 58 formed around the circumference of the first opening 42 of the fabric cover 40. Ends of the drawstring 54 may be secured with a fastening device, as is known in the art, which is selectively movable along the length of the drawstring 54 and allows the user to retain the drawstring 54 at various locations, thereby making the first opening 42 smaller or larger. Movement of the drawstring 54 within the conduit 58 may allow for selective adjustment of the size of the first opening 42. In use, the drawstring 54 may be used to tightly and snugly fit the top of the fabric cover 40 about the fermenting cover 20, such that the first opening 42 contacts the airlock device 30, namely, the stem of the airlock device 30. When the fabric cover 40 needs to be removed (or installed) from the fermenting container 20, the drawstring 54 may be loosened to enlarge the first opening 42, such as larger than the airlock device 30 or larger than the diameter of the fermenting container 20, thereby allowing the fabric cover 40 to be removed without lifting, moving, or otherwise disturbing the fermenting container 20.

As is shown in FIG. 2, the first opening 42 of the fabric cover 40 may be positioned surrounding the straw 34 of the airlock device 30, such that it nearly or closely abuts the exterior surface of the straw 34. In this position, the size of the first opening 42 may be smaller than a cross-sectional size of the body 32 of the airlock device 30. Optionally, the fabric cover 40 may be sized to fit around the perimeter of the lid 22, which may be desired when the lid 22 is itself decorative or has UV blocking properties. It is noted that when the drawstring 54 is formed within a conduit 58 that is constructed from a lighter-weight fabric material 52, the first opening 42 may be more easily adjusted in size than if the conduit 58 is formed from heavy-weight material. Many alternatives to the drawstring 54 exist, such as hook-and-loop fasteners, snap button fasteners, and elastic-based closures, etc., all of which are considered within the scope of the present disclosure.

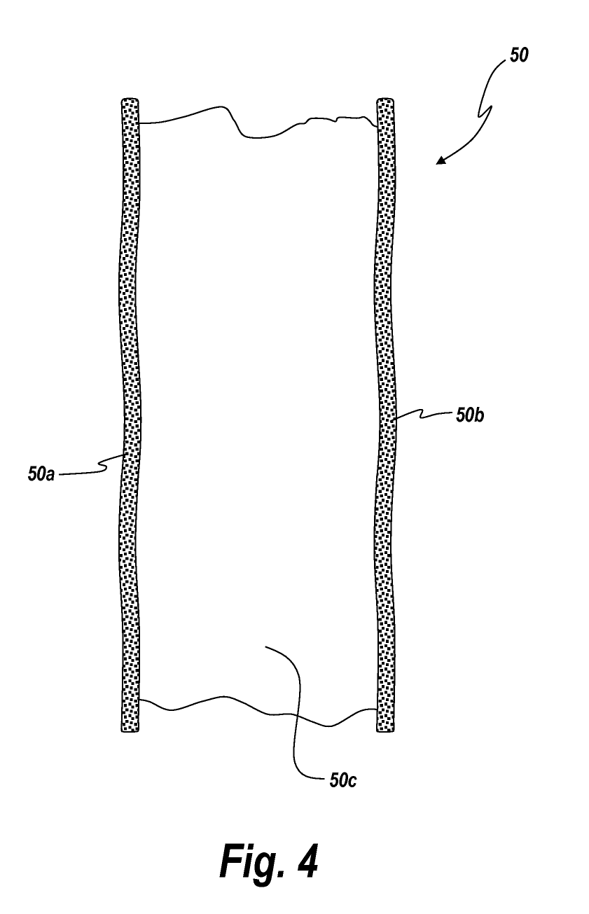

FIG. 4 is a detailed view cross-sectional illustration of a section of the fabric cover 40, in accordance with the first exemplary embodiment of the present disclosure. Relative to FIGS. 3-4, as one of many alternatives to constructing the fabric cover 40 from a single heavy-weight fabric, multiple layers of fabric material may be used. For example, as is shown in FIG. 4, a double layer of fabric may include two layers of fabric material, 50a, 50b which are positioned parallel to each other. An additional material, such as an insulating material 50c, may be positioned between the two lawyers of fabric 50a, 50b. For example, the double layer of fabric may have air-infused insulation material 50c, positioned between the two layers to increase an insulation capacity of the fabric cover 40 and increase an ability to block UV light of the fabric cover 40.

In one of many additional features, the fabric cover 40 may be reversible such that it can be turned inside-out, thereby allowing the user to select which of the fabric materials to make visible. For example, each of the two layers of fabric material 50a, 50b may include a different pattern, thereby allowing the user the option of selecting which pattern to display on the outside of the fermenting container. Further, these two layers alone, without an internal insulation layer, may increase the UV light blocking capabilities of the fabric cover 40 and the insulating capabilities of the fabric cover 40, e.g., due to the air trapped between the two layers of fabric material 50a, 50b.

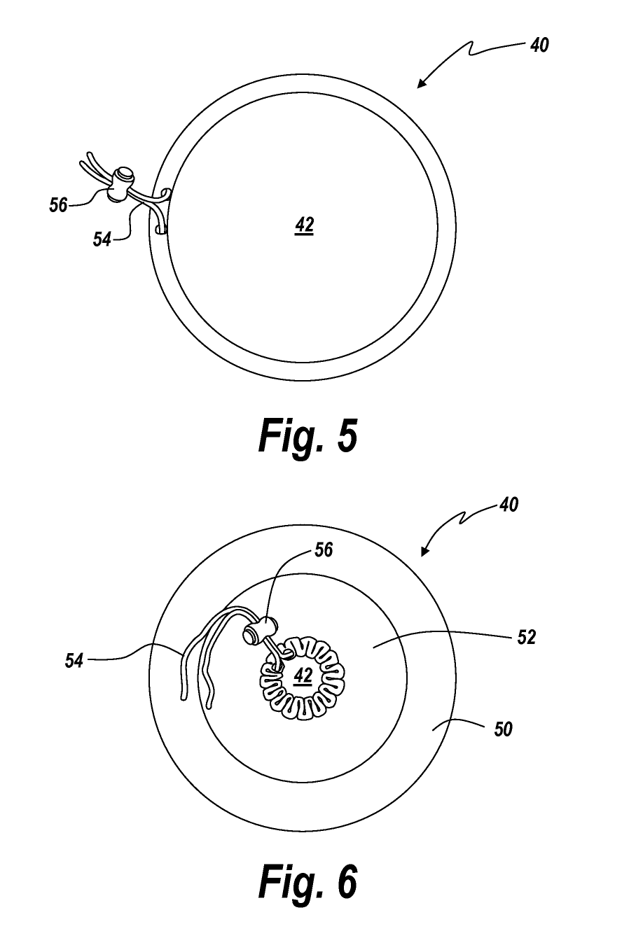

FIG. 5 is a top view illustration of the fabric cover 40 of FIG. 1, in accordance with the first exemplary embodiment of the present disclosure. FIG. 6 is a top view illustration of the fabric cover 40 of FIG. 1, in accordance with the first exemplary embodiment of the present disclosure. With reference to FIGS. 5-6, the selective adjustability of the size of the first opening 42 of the fabric cover 40 can be seen. In particular, FIG. 5 illustrates the fabric cover 40 having an enlarged first opening 42, whereby the drawstring 54 is not tightened within the conduit 58. As can be seen, the fastening device 56 is positioned proximate to a terminating end of the drawstring 54. FIG. 6 illustrates the fabric cover 40 with the first opening 42 cinched, such as if it were snugly closed around an airlock device 30 (FIG. 2). In this position, the drawstring 54 may be pulled tightly within the conduit 58 of the second fabric material 52 and the fastening device 56 is used to retain it in a static position. When viewing FIGS. 5-6 in combination with FIG. 2, it may be understood that while the second fabric material 52 may be positioned around the lid 22 of the fermenting container 20, the first fabric material 50 may be positioned around the top corner edge of the fermenting container 20 and around the sides of the fermenting container 20.

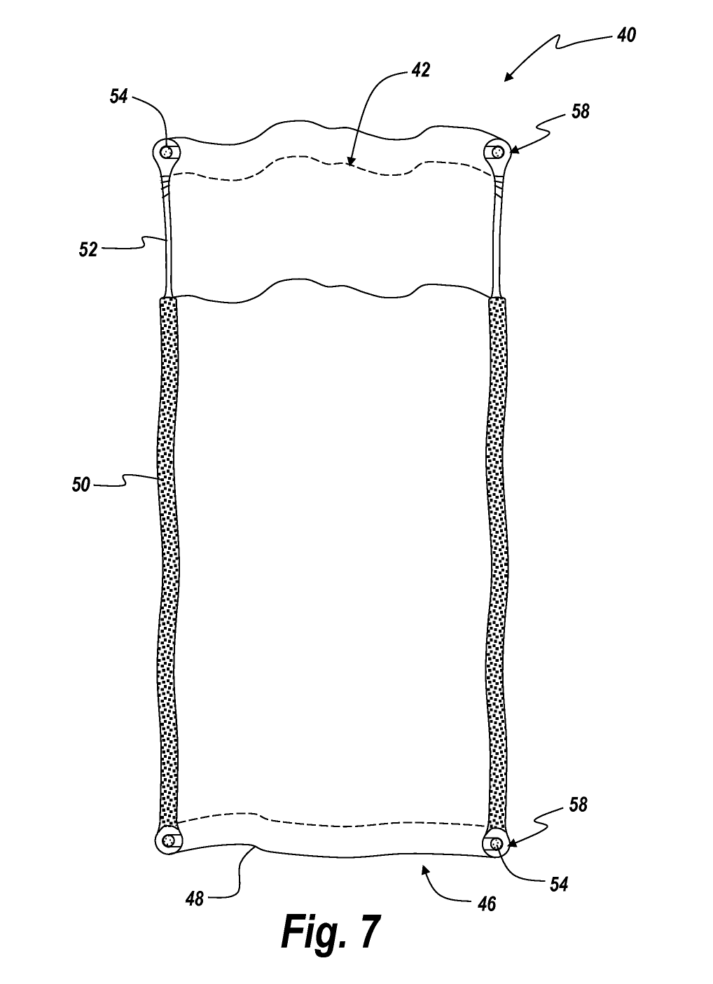

FIG. 7 is a cross-sectional illustration of the fabric cover 40, in accordance with the first exemplary embodiment of the present disclosure. Many optional components, features, and configurations exist and can be included with the system 10. For example, the fabric cover 40 may have an open bottom, a closed bottom, or a bottom with a drawstring 54 that is movable within a conduit 58 positioned along a circumference of the second opening 46. This second drawstring 54 with second conduit 58 may allow adjustment of the bottom 48 of the fabric cover 40 about the base of the fermenting container 20 (FIG. 2) or under the fermenting container 20 (FIG. 2). When the bottom 48 includes the drawstring 54, the fabric cover 40 may have a bag-shape with drawstrings 54 at each end. When the drawstring 54 is moved through the conduit 58, the size of the second opening 46 may be selectively adjusted. The bottom 48 of the fabric cover 40 may also be padded or insulated to provide protection to the bottom of the fermenting container 20, such as from a cold countertop. In this example, the fabric cover 40 may be similar to a one-piece bag used to cover the fermenting container 20. Many variations exist, all of which are considered to be within the scope of the present disclosure.

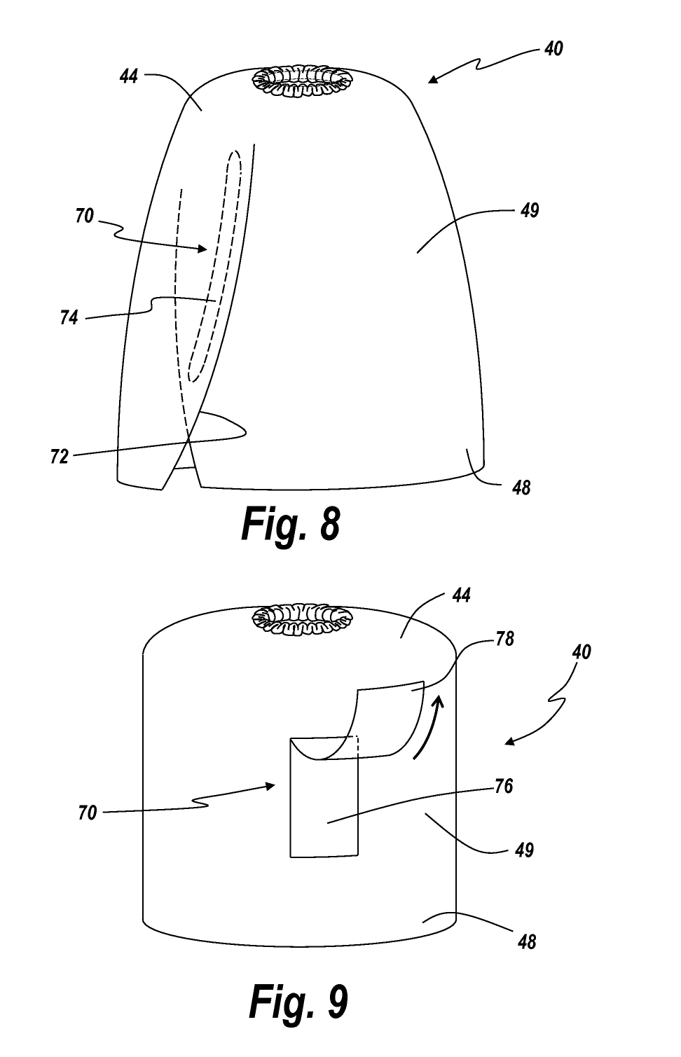

FIG. 8 is a side view illustration of the fabric cover 40, in accordance with the first exemplary embodiment of the present disclosure. FIG. 9 is a side view illustration of the fabric cover 40, in accordance with the first exemplary embodiment of the present disclosure. The fabric cover 40 may further include one or more openable windows 70 positioned within a middle section 49 of the fabric cover 40. The window 70 may be selectively closeable, such that a user can open or shut the window 70 as desired. The window 70 of the fabric cover 40 may be opened to visually see the fermenting container 20 without removal of the entire fabric cover 40.

In FIG. 8, the openable window 70 further comprises a slit 72 formed within the fabric cover 40 from overlapping fabric pieces and positioned along a length thereof, such as from the bottom 48 of the fabric cover 40 through or past a middle section 49 thereof. In FIG. 8, the slit 72 is formed from a break in the fabric cover 40 which runs from the bottom 48 of the fabric cover 40 almost to the top 44 of the fabric cover. A fastening device 74, such as a hook and loop fastener, illustrated in broken lines, may be used to keep the slit 72 closed. In FIG. 9, the window 70 may include an aperture 76 positioned in the middle section 49 of the fabric cover 40 that has a flap 78 which is closeable on the aperture 76. Additional aspects of the system 10, not detailed herein, may include a write-on area on the fabric cover 40 for labeling/dating or a fastener system for affixing labels or images to the fabric cover 40.

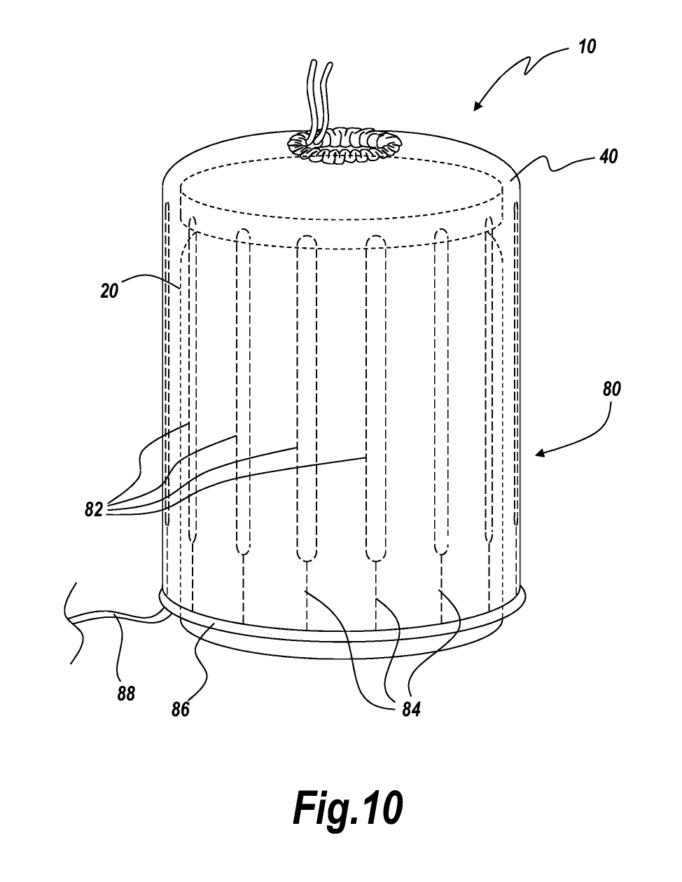

FIG. 10 is a side view illustration of the fabric cover with a temperature control device 80, in accordance with the first exemplary embodiment of the present disclosure. The temperature control device 80 may be incorporated into the fabric cover 40, or otherwise affixed thereto, to provide the user with the ability to regulate the temperature of the fermenting container 20. If a fermenting container 20 gets too hot or too cold, the fermentation process can be affected negatively. The fabric cover 40 may provide some regulation of temperature, but in some situations, it may be necessary to either heat or cool the temperature of the fermenting container 20. The temperature control device 80 may use a variety of different devices to either heat or cool the fermenting cover 20.

In one design, as shown in FIG. 10, the temperature control device 80 may use solid state thermoelectric heating & cooling elements which utilize the Peltier effect to create a heat flux between two materials by passing a current through the junction between the two material. The result is where one material can be cooled while the other is heated. The thermoelectric heating & cooling elements include a plurality of thermocouples 82 which are embedded within the fabric cover 40 or affixed thereto and thermostatically controlled. Each of the thermocouples 82 is connected with a lead line 84 to an array 86 which can be interfaced with a power source, such as an electrical wire 88. The electrical wire 88 may include any power source, including a USB port or USB power adapter. Other circuitry, as is known in the art, may also be included in the temperature control device 80 to enable successful functioning of the temperature control device 80.

The thermocouples 82 may be arranged with each of the two materials of the heat flux being positioned on separate sides of the fabric cover 40, such that one side of the fabric cover 40 is a heated side and the other side is a cooled side. The user can invert the fabric cover 40 placing the appropriate side against the fermenting container 20 to either heat or cool the fermenting container 20, as desired. Any number of thermocouples 82 or other components of the temperature control device 80 can be used to achieve a desired heating or cooling, as may be dependent on the design of the system 10. In another example, the temperature control device 80 may include a square thermoelectric device that is affixed to the cover, such as in pockets within the cover or otherwise fastened to it. The thermoelectric device may also require an external heat-sink on the outside of the fabric cover 140.

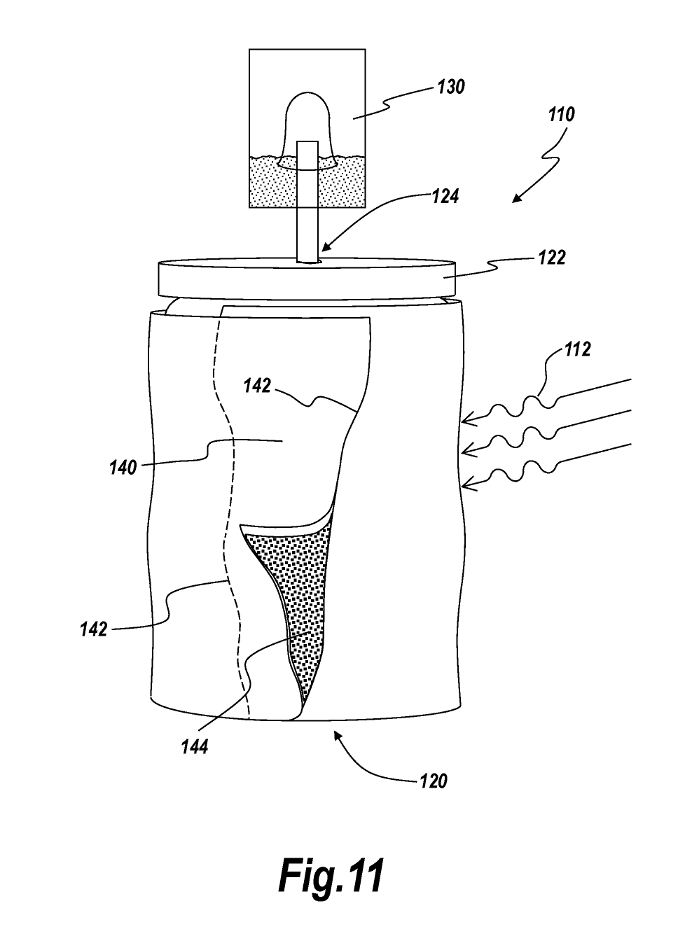

FIG. 11 is a side view illustration of the fabric cover, in accordance with a second exemplary embodiment of the present disclosure. The fermenting container system 110, which may be referred to herein simply as ‘system 110’, may be substantially similar to the fermenting container system 10 of the first exemplary embodiment, and may include any of the features, components, or functions discussed relative to the first exemplary embodiments. As is shown in FIG. 11, the system 110 includes a fermenting container 120 having a lid 122. The lid 122 has at least one hole 124 positioned there through. An airlock device 130 is positioned at least partially within the at least one hole 124, wherein the airlock device 130 extends away from the lid 122.

A fabric cover 140 is positioned surrounding the fermenting container 220. The fabric cover 140 may have an elongated length and may be wrapped around the fermenting container 120 to cover it from UV light 112. The fabric cover 140 as a wrap may have any size, length, or thickness, and may be wrapped around the fermenting container 120 any number of times with any overlaps. As is shown in FIG. 11, the fabric cover 140 may be sized to wrap around the fermenting container 120 once with overlap between the edges 142 thereof. A portion of the fabric cover 140, such as one of the edges 142 thereof, may include a fastening device 144 which can be used to retain the fabric cover 140 on the fermenting container 120. The fastening device 144 may include a variety of fasteners, including hook-and-loop fasteners, fabric clips, adhesives, or other structures. The fabric cover 140 may be wrapped about the fermenting container 120 in such a way that it abuts the airlock device 130 and substantially surrounds the lid 122 and sides of the fermenting container 120. The functioning of the fabric cover 140 to block UV light 112, and the benefits thereof, may be substantially similar to that described relative to FIGS. 1-11.

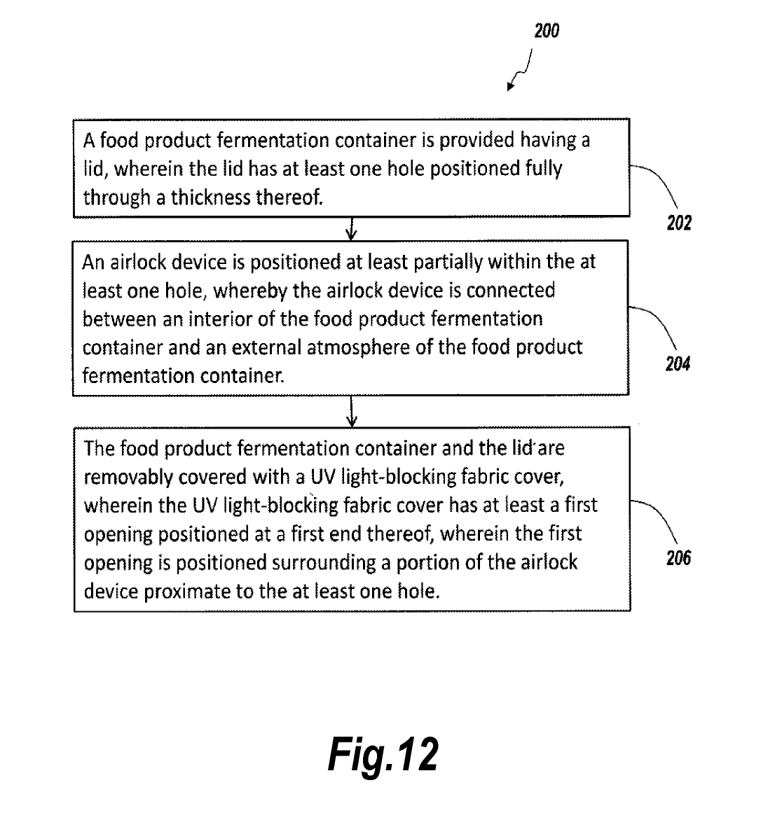

FIG. 12 is a flowchart 200 illustrating a method of blocking UV light in a food product fermentation system, in accordance with the first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 202, a food product fermentation container is provided having a lid, wherein the lid has at least one hole positioned fully through a thickness thereof. An airlock device is positioned at least partially within the at least one hole, whereby the airlock device is connected between an interior of the food product fermentation container and an external atmosphere of the food product fermentation container (block 204). The food product fermentation container and the lid are removably covered with a UV light-blocking fabric cover, wherein the UV light-blocking fabric cover has at least a first opening positioned at a first end thereof, wherein the first opening is positioned surrounding a portion of the airlock device proximate to the at least one hole (block 206).

The method may include any additional number of steps, processes, or functions, including any disclosed relative to FIGS. 1-11. For example, the method may include selectively adjusting a size of the first opening of the UV light-blocking fabric by moving a drawstring through a conduit formed within the UV light-blocking fabric cover, wherein the conduit is positioned around a circumference of the first opening. The drawstring may be retained in a stationary position within the conduit using a fastener. The airlock device may include a body positioned above the lid of the food product fermentation container and a straw positioned through a hole within the lid, wherein the first opening of the UV light-blocking fabric cover is positioned surrounding the straw. When the size of the first opening of the UV light-blocking fabric is selectively adjusted, it may be decreased to have a smaller cross-sectional size than at least a portion of the airlock device, such as the body of the airlock device. Covering the food product fermentation container and the lid with the UV light-blocking fabric cover may block all or substantially all UV light from a food product positioned within an interior of the food product fermentation container.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A fermenting container system comprising:
a fermenting container having a lid, wherein the lid has at least one hole positioned there through;
an airlock device positioned at least partially within the at least one hole, wherein the airlock device extends away from the lid; and
a fabric cover positioned surrounding the fermenting container, the fabric cover having at least a first opening positioned at a first end thereof, wherein the first opening is positioned surrounding a portion of the airlock device proximate to the at least one hole, and wherein a size of the first opening is selectively adjustable.

2. The fermenting container system of claim 1, wherein the fermenting container further comprises a UV light penetrable material and wherein at least a portion of the fabric cover comprises a UV light blocking material.

3. The fermenting container system of claim 2, wherein the UV light blocking material of the fabric cover prevents UV light from contacting a food product positioned within an interior of the fermenting container.

4. The fermenting container system of claim 1, further comprising a conduit formed within the fabric cover and positioned around a circumference of the first opening, wherein a drawstring is positioned through the conduit, wherein movement of the drawstring within the conduit selectively adjusts the size of the first opening.

5. The fermenting container system of claim 4, further comprising a fastener selectively movable along a length of the drawstring.

6. The fermenting container system of claim 1, wherein the airlock device further comprises a body positioned above the lid of the fermenting container and a straw positioned through a hole within the lid, wherein the first opening of the fabric cover is positioned surrounding the straw.

7. The fermenting container system of claim 6, wherein the size of the first opening is smaller than a cross-sectional size of the body of the airlock device.

8. The fermenting container system of claim 1, further comprising a quantity of fermenting food products positioned within the fermenting container, wherein the quantity of fermenting food product is not viewable through the fabric cover.

9. The fermenting container system of claim 1, wherein the fabric cover further comprises a first fabric material and a second fabric material, wherein the first fabric material is a heavy-weight material and the second fabric material is a light-weight material, wherein the light-weight material is positioned substantially above the lid.

10. The fermenting container system of claim 9, wherein the heavy-weight material further comprises at least two layers of heavy-weight material with an insulating material positioned therebetween.

11. The fermenting container system of claim 1, wherein the fabric cover has at least a second opening positioned at a second end thereof, wherein the second end is positioned proximate to a base of the fermenting container.

12. The fermenting container system of claim 11, further comprising a conduit formed within the fabric cover and positioned around a circumference of the second opening, wherein a drawstring is positioned through the conduit, wherein movement of the drawstring within the conduit selectively adjusts the size of the second opening.

13. The fermenting container system of claim 1, wherein the fabric cover further comprises at least one openable window positioned within a middle section thereof, wherein the window is selectively closeable, wherein the at least one openable window further comprises at least one of:
an openable window having a window flap removable from a covering position of the openable window; and
a slit formed within the fabric cover and positioned along a length thereof.

14. A UV light-blocking, food product fermentation system comprising:
a fermentation container having a lid, wherein the lid has at least one hole positioned fully through a thickness thereof, wherein a food product is housed within an interior of the fermentation container;
an airlock device positioned at least partially within the at least one hole, the airlock device connected between the interior of the fermentation container and an external atmosphere of the fermentation container;
a UV light-blocking fabric cover removably positioned surrounding the fermenting container, the UV light-blocking fabric cover having at least a first opening positioned at a first end thereof, wherein the first opening is positioned surrounding a portion of the airlock device proximate to the at least one hole; and
a conduit formed within the UV light-blocking fabric cover and positioned around a circumference of the first opening, wherein a drawstring is positioned through the conduit, wherein a size of the first opening is selectively adjustable by moving the drawstring within the conduit.

15. A method of blocking UV light in a food product fermentation system, the method comprising:
providing a food product fermentation container having a lid, wherein the lid has at least one hole positioned fully through a thickness thereof;
positioning an airlock device at least partially within the at least one hole, whereby the airlock device is connected between an interior of the food product fermentation container and an external atmosphere of the food product fermentation container; and
removably covering the food product fermentation container and the lid with a UV light-blocking fabric cover, wherein the UV light-blocking fabric cover has at least a first opening positioned at a first end thereof, wherein the first opening is positioned surrounding a portion of the airlock device proximate to the at least one hole.

16. The method of claim 15, further comprising selectively adjusting a size of the first opening of the UV light-blocking fabric by moving a drawstring through a conduit formed within the UV light-blocking fabric cover, wherein the conduit is positioned around a circumference of the first opening.

17. The method of claim 16, further comprising retaining the drawstring in a stationary position within the conduit using a fastener.

18. The method of claim 16, wherein selectively adjusting the size of the first opening of the UV light-blocking fabric by moving the drawstring through the conduit formed within the UV light-blocking fabric cover further comprises decreasing the size of the first opening to have a smaller cross-sectional size than at least a portion of the airlock device.

19. The method of claim 15, wherein the airlock device further comprises a body positioned above the lid of the food product fermentation container and a straw positioned through a hole within the lid, wherein the first opening of the UV light-blocking fabric cover is positioned surrounding the straw.

20. The method of claim 15, wherein removably covering the food product fermentation container and the lid with the UV light-blocking fabric cover further comprises blocking all UV light from a food product positioned within an interior of the food product fermentation container.
